(19) United States
(12) Patent Application Publication
(10) Pub. No.: US 2018/0363873 A1
(43) Pub. Date: Dec. 20, 2018

(54) GRILL-MOUNTED ADJUSTABLE LIGHT ASSEMBLY

(71) Applicant: Performance Design Group USA Inc., Hawthorne, CA (US)

(72) Inventors: Jerry Loaiza, Hawthorne, CA (US); Jeff Tummers, Park City, UT (US); Shahe Kalaydjian, Calabasas, CA (US)

(21) Appl. No.: 16/012,617

(22) Filed: Jun. 19, 2018

Related U.S. Application Data
(60) Provisional application No. 62/522,575, filed on Jun. 20, 2017.

(51) Int. Cl. F21S 41/19; F21S 41/47

(52) U.S. Cl. CPC F21S 41/192; F21W 2107/10; F21S 41/47

(57) ABSTRACT

An adjustable light assembly configured to be mounted to a vehicle grill includes a mounting ring configured to clamp onto a portion of the vehicle grill and a light supporting member configured to support a light in alignment with a central opening of the mounting ring. The light supporting member is connected to the mounting ring. The mounting ring and/or the light supporting member are configured to permit adjustment of the light relative to the mounting ring. The mounting ring can include a front ring and a rear ring that are coupled to one another to clamp the vehicle grill therebetween. In some configurations, the light supporting member is coupled to the mounting ring by a spheroidal joint. In some configurations the light supporting member is a bracket connected to the mounting ring.

### INCORPORATION BY REFERENCE TO ANY PRIORITY APPLICATIONS

The entirety of any and all applications for which a foreign or domestic priority claim is identified in the Application Data Sheet as filed with the present application are hereby incorporated by reference herein and made a part of the present disclosure.

### BACKGROUND

### Field

The present disclosure involves light assemblies for vehicles. In particular, the present disclosure is directed towards a grill-mounted, adjustable light assembly for a vehicle.

### Description of the Related Art

Existing light assemblies for vehicles often are non-adjustable or provide limited adjustability. If adjustable, existing light assemblies are often complicated, heavy and/or expensive to manufacture.

Lights configured to be mounted to a vehicle grill or within a vehicle grill often utilize a bracket attached to the grill to which the light assembly is mounted. In some arrangements, the grill defines an opening within which the light assembly is mounted. The grill opening often includes a reinforcing member or structure surrounding the opening. In some arrangements, the light is secured directly to the grill. Such arrangements increase the complexity and, thus, the cost of the vehicle grill.

### SUMMARY

The systems, methods and devices described herein have innovative aspects, no single one of which is indispensable or solely responsible for their desirable attributes. Without limiting the scope of the claims, some of the advantageous features will now be summarized.

An adjustable light assembly configured to be mounted to a vehicle grill includes a mounting ring configured to clamp onto a portion of the vehicle grill. The light assembly also includes a light supporting member configured to support a light in alignment with a central opening of the mounting ring. The light supporting member is connected to the mounting ring. The mounting ring and/or the light supporting member are configured to permit adjustment of the light relative to the mounting ring.

In some configurations, the mounting ring comprises a front ring and a rear ring that are connectable to one another and configured to receive the portion of the vehicle grill therebetween.

In some configurations, wherein the mounting ring is circular.

In some configurations, wherein the light supporting member and the mounting ring are coupled by a spheroidal joint.

In some configurations, the front ring and the rear ring are configured to fix a position of the light supporting member relative to the mounting ring when front ring and the rear ring are clamped to the portion of the vehicle grill.

In some configurations, the light supporting member supports a resilient ring member within the spheroidal joint.

In some configurations, the light supporting member is a bracket that is affixed to the mounting ring.

In some configurations, the bracket is affixed to one of the front ring and the rear ring.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings.

FIG. 1 is an exploded view of a light assembly.

FIG. 2 is a sectional view of a mounting portion of the light assembly.

FIG. 3 is a front perspective view of the light assembly.

FIG. 4 is a rear perspective view of the light assembly.

FIG. 5 is a front view of an alternative light assembly.

FIG. 6 is a side view of the light assembly of FIG. 5.

FIG. 7 is a rear perspective view of the light assembly of FIGS. 5 and 6 illustrating a light-mounting bracket.

### DETAILED DESCRIPTION

Embodiments of systems, components and methods of assembly and manufacture will now be described with reference to the accompanying figures, wherein like numerals refer to like or similar elements throughout. Although several embodiments, examples and illustrations are disclosed below, it will be understood by those of ordinary skill in the art that the inventions described herein extends beyond the specifically disclosed embodiments, examples and illustrations, and can include other uses of the inventions and obvious modifications and equivalents thereof. The terminology used in the description presented herein is not intended to be interpreted in any limited or restrictive manner simply because it is being used in conjunction with a detailed description of certain specific embodiments of the inventions. In addition, embodiments of the inventions can comprise several novel features and no single feature is solely responsible for its desirable attributes or is essential to practicing the inventions herein described.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

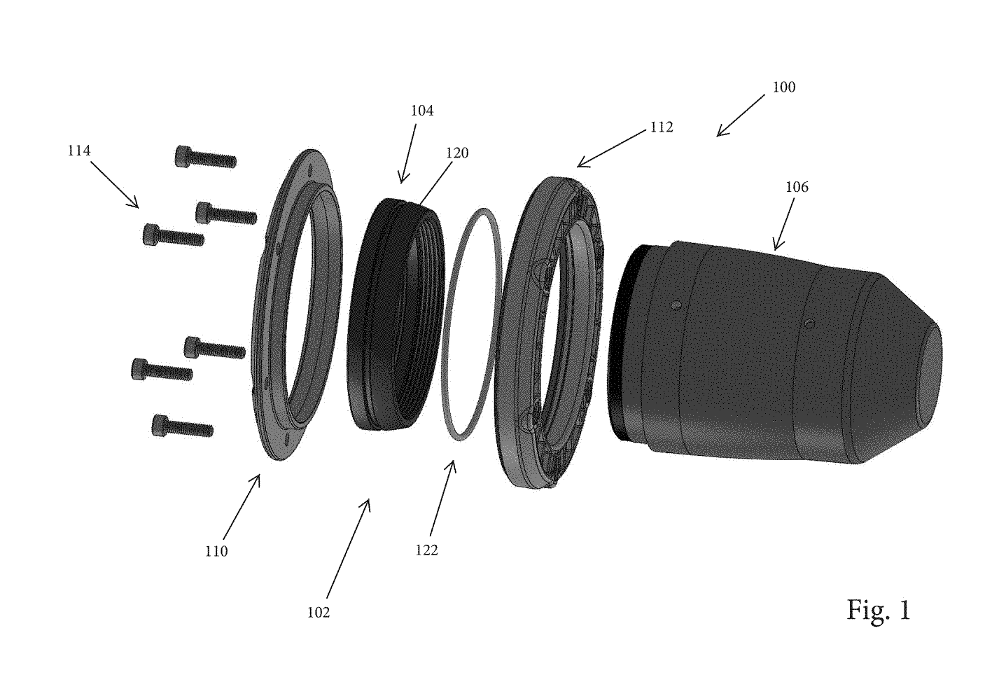

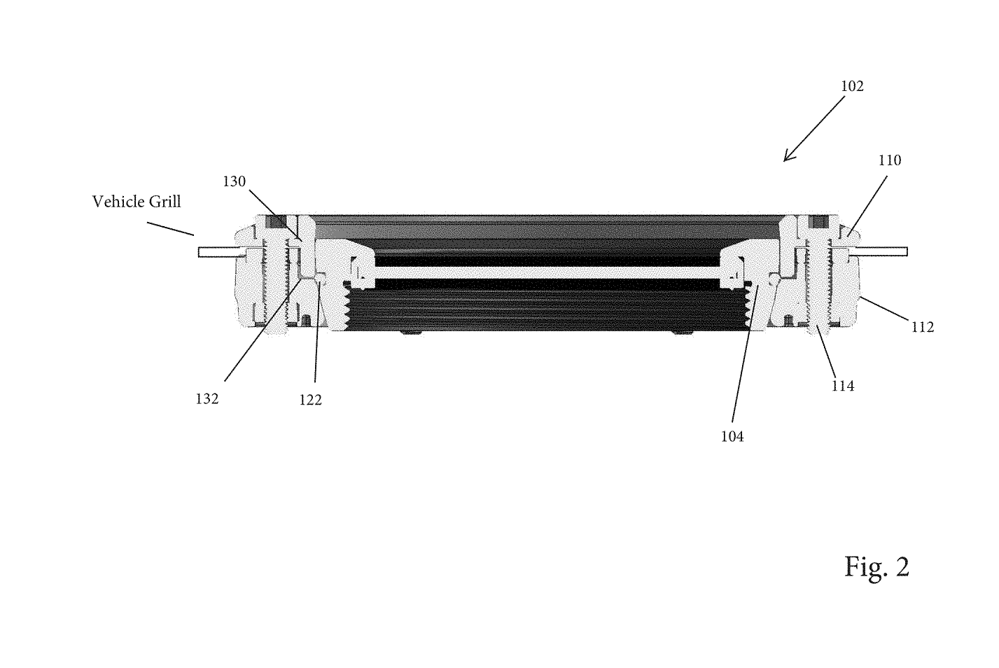

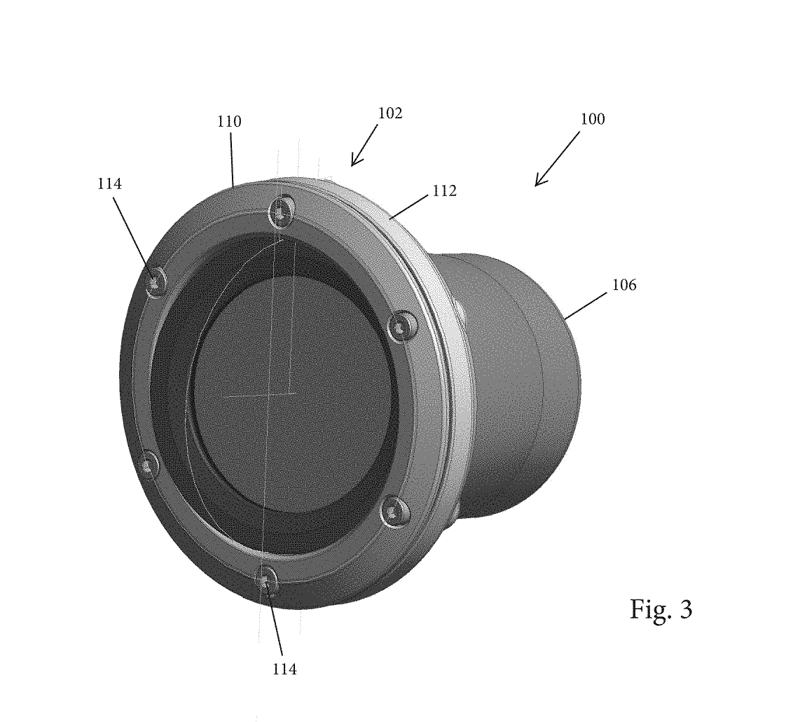

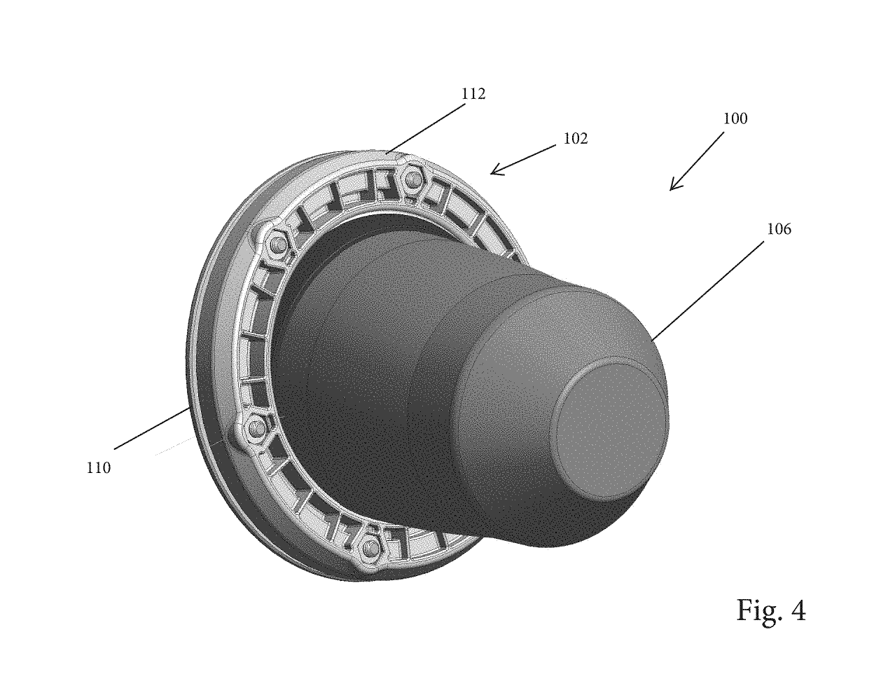

FIGS. 1-4 illustrate a configuration of a light assembly 100 especially well-suited for mounting to a vehicle grill. However, in other configurations, the light assembly 100 could be mounted to, or modified for mounting to, other portions of a vehicle or other objects, such as relatively thin plates, sheets or thin flanges. In some configurations, the vehicle grill can be an expanded metal grill, which can include one or more openings configured to accommodate the light assembly 100. The light assembly 100 is suitable for use with, or can be modified for use with, other types of grills, as well.

In the illustrated arrangement, the light assembly 100 includes a mount in the form of a mounting ring 102 and a light support in the form of a light supporting member 104. The mounting ring 102 and the light supporting member 104 cooperate to support a light 106. Preferably, the light 106 is supported for adjustment relative to the mounting ring 102. In some configurations, the light 106 is adjustable about at least one axis of movement. In some configurations, the light 106 is adjustable about at least two axes of movement.

In the illustrated arrangement, the light supporting member 104 interacts with the mounting ring 102 via a ball-and-socket or spheroidal joint. That is, the mounting ring 102 defines a first spheroidal surface and the light supporting member 104 defines a second spheroidal surface that faces the first spheroidal surface. Such an arrangement permits angular adjustment of the light 102 in any direction within the available adjustment range. In addition, the adjustment can be accomplished by movement of the light 102 about two axes of adjustment at the same time. That is, the illustrated arrangement provides additional adjustability compared to light assemblies that permit adjustment only about a single axis of movement. Furthermore, the illustrated arrangement provides a simpler adjustment process relative to light assemblies that provide separate adjustment mechanisms for each adjustment direction (e.g., up-and-down and side-to-side).

The illustrated arrangement allows for the light 106 to be easily fixed in a desired adjustment position. In addition, the illustrated arrangement allows for quick and simple installation to a vehicle grill or other suitable mounting structure. For example, the illustrated mounting ring 102 is configured for mounting to a portion of a vehicle grill that defines an opening. The vehicle grill can completely surround the opening to form a closed loop. In other arrangements, the vehicle grill may not form a closed loop around the opening and only a portion of the mounting ring 102 may engage the vehicle grill.

The illustrated mounting ring 102 includes a front ring 110 and a rear ring 112 that are configured to be selectively coupled to one another, such as by a plurality of fasteners 114 (e.g., bolts). However, other suitable arrangements to selectively couple the front ring 110 and the rear ring 112 can also be used. The mounting ring 102 is configured to clamp the portion of the vehicle grill surrounding the opening between the front ring 110 and the rear ring 112. Thus, to assembly the light assembly 100 to the vehicle grill, the front ring 110 is positioned on the front side of the grill and the rear ring 112 is positioned on the rear side of the grill. The light supporting member 104 is positioned between the front ring 110 and the rear ring 112. The front ring 110 and the rear ring 112 are then coupled to capture the vehicle grill and the light supporting member 104 therebetween. The light 106 can be adjusted to a desired adjustment position and then the front ring 110 and the rear ring 112 can be tightened (moved closer to one another) to clamp the vehicle grill and secure the light 106 in the desired adjustment position.

Preferably, the front ring 110 covers the portion of the vehicle grill when viewed from the front. Such an arrangement provides an attractive appearance by eliminating gaps between the vehicle grill and the light assembly, which can be present in other light assemblies. Such gaps may not be even around the entirety of the light assembly, which can provide an unattractive appearance. Moreover, the illustrated arrangement can reinforce the vehicle grill around the opening as a result of the front ring 110 and the rear ring 112 being clamped to the portion of the vehicle grill surrounding the opening. Such an arrangement requires less structural reinforcement around the opening of the vehicle grill in comparison to other designs.

In the illustrated arrangement, each of the front ring 110 and the rear ring 112 define a portion of the spheroidal surface of the mounting ring 102. However, in other arrangements, one or the other of the front ring 110 and the rear ring 112 can define an entirety of the spheroidal surface. In such arrangements, the one of the front ring 110 and the rear ring 112 that does not include the spheroidal surface can operate to push the light supporting member 104 tightly against the spheroidal surface of the other of the front ring 110 and the rear ring 112.

As described, the light supporting member 104 defines a spheroidal surface that is configured to fit within and cooperate with the spheroidal surface of the mounting ring 102. Preferably, the spheroidal surfaces are configured to have a relatively tight fit such that clamping of the front ring 110 and the rear ring 112 is capable of securing the light supporting member 104 in a fixed position relative to the mounting ring 102 while supporting the light 106 and resist or prevent significant movement of the light 106 under normal operating conditions (e.g., as a result of vehicle vibrations or forces experienced by the vehicle grill during normal operation).

In the illustrated arrangement, the light supporting member 104 defines a groove 120 that interrupts the spheroidal surface and is configured to receive a resilient ring member 122, such as a rubber O-ring, for example. The resilient ring member 122 is configured to frictionally engage the spheroidal surface of the mounting ring 102. Thus, in some configurations, the resilient ring member 122 can facilitate positional adjustment of the light 106 by maintaining the light supporting member 104 (and light 106) in a desired position relative to the mounting ring 102 during the adjustment process prior to the front ring 110 and the rear ring 112 being fully secured to one another to fully clamp the vehicle grill and fix the position of the light supporting member 104. Accordingly, a user can assemble the front ring 110, light supporting member 104 and rear ring 112, as described above, and can adjust the light 106 to a desired position. The resilient ring member 122 can temporarily hold the adjusted position of the light 106 while the user fully tightens the fasteners 114 or otherwise moves the front ring 110 and the rear ring 112 into a fully tightened position relative to one another. The resilient ring member 122 can also assist in inhibiting or preventing movement of the light supporting member 104 relative to the mounting ring 102 after assembly is complete by increasing the friction between the mounting ring 102 and the light supporting member 104 relative to the holding force provided solely by the spheroidal joint arrangement.

The light 106 can be mounted to the light supporting member 104 by any suitable arrangement. In the illustrated arrangement, the light 106 includes a threaded projection that is configured to engage with a threaded opening of the light supporting member 104. However, other suitable arrangements (e.g., a clamping arrangement) can also be used. In addition, the light supporting member 104 could be integrated or formed unitarily with the light 106.

In the illustrated arrangement, the front ring 110 includes a rearwardly-projecting cylindrical lip 130 that is received within a forward-facing recess 132 of the rear ring 112. The lip 130 and recess 132 facilitate proper axial alignment of the front ring 110 and the rear ring 112 during assembly. Such a feature is advantageous because the rings 110, 112 are positioned on opposite sides of the vehicle grill and visual sighting and location of the rings 110, 112 relative to one another may be impaired.

Components of the light assembly 100 can be made of any suitable material or combination of materials by any suitable process or combination of processes. For example, the front ring 110 and rear ring 112 of the mounting ring 102 and the light supporting member 104 can be made from a suitable metal material, such as aluminum. In some configurations, some or all of these components can be constructed from a plastic material. In some configurations, the front ring 110 is metal and the rear ring 112 is plastic. Such an arrangement reduces costs while preserving the outward appearance of the light assembly 100.

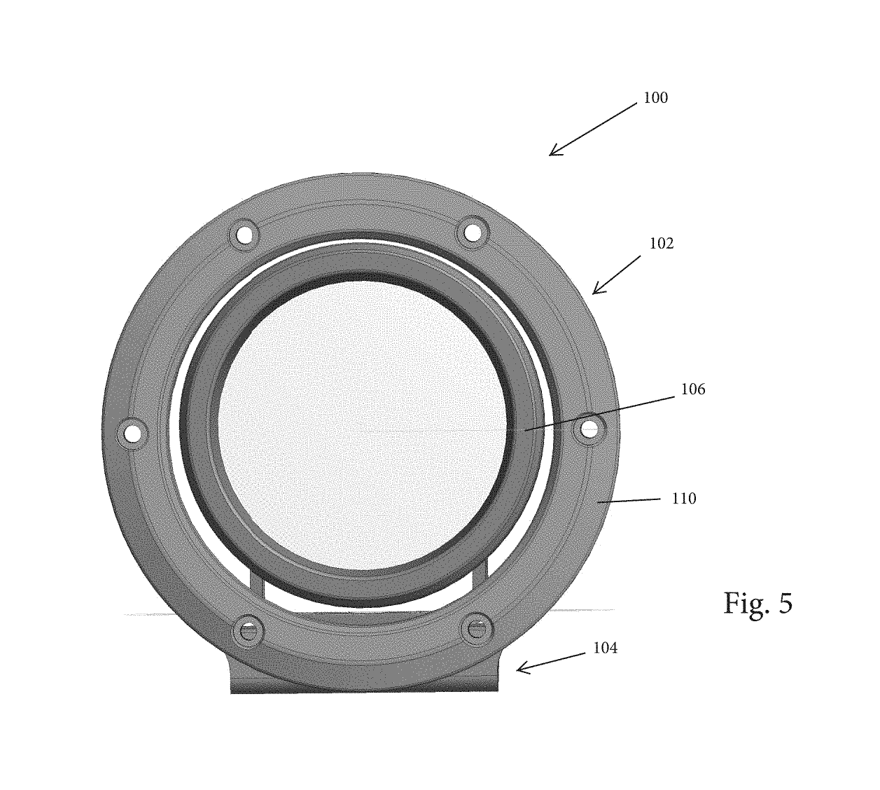

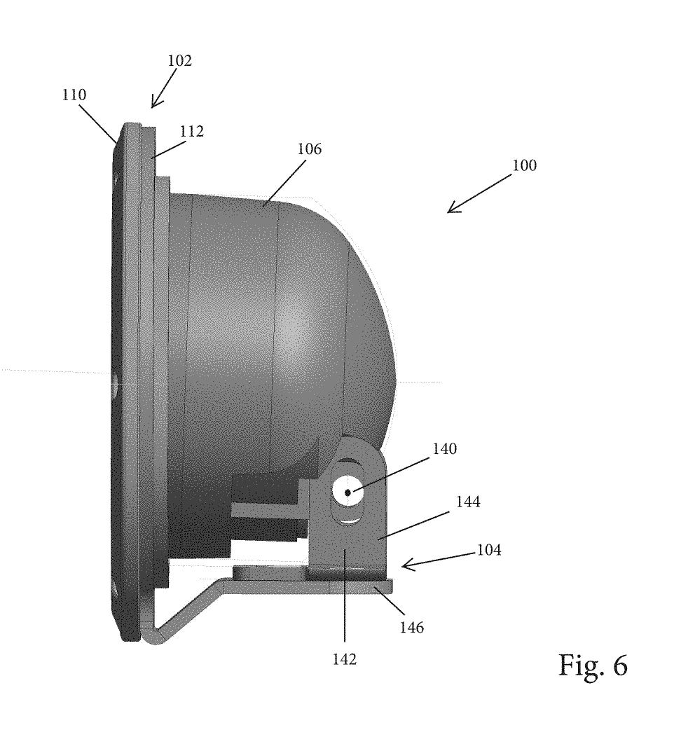

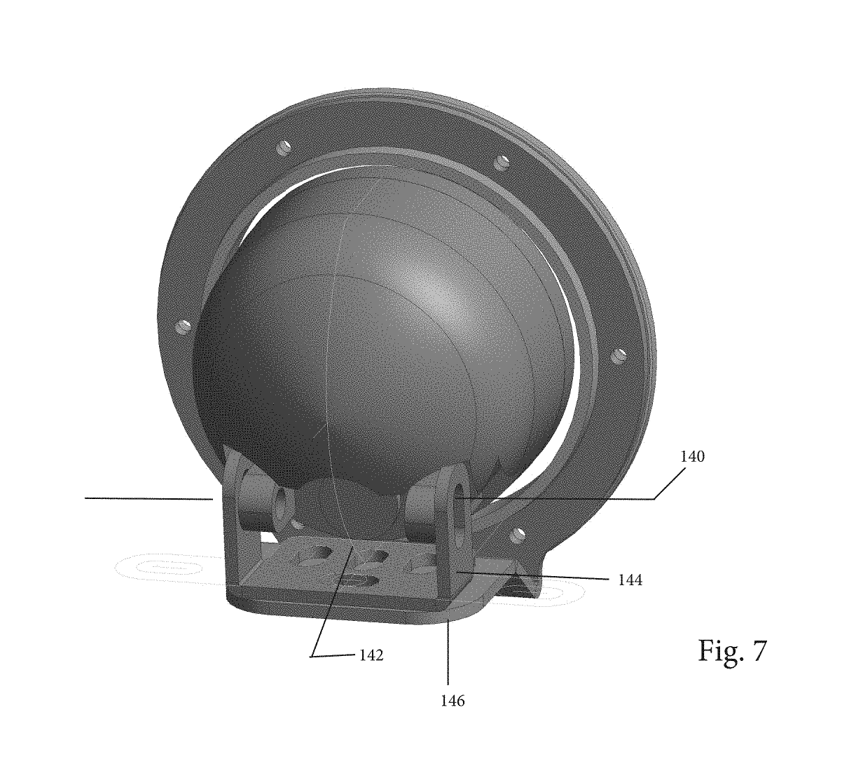

FIGS. 5-7 illustrate an alternative light assembly 100. In many respects, the light assembly 100 of FIGS. 5-7 is similar to the light assembly of FIGS. 1-4. Thus, the same reference numbers are utilized to refer to the same or corresponding parts or features. Also, the description below is focused on the differences relative to the previous light assembly 100. Thus, components or features not described in detail can be assumed to be the same as or similar to the same or corresponding component or feature of the previous light assembly 100, or can be of a suitable arrangement.

In the arrangement of FIGS. 5-7, the light 106 is supported by a light supporting member 104 in the form of a bracket. The bracket 104 is supported by the rear ring 112. The bracket 104 can be directly coupled to or unitarily-formed with the rear ring 112, as illustrated. The light 106 can be adjustably-supported by the bracket 104. For example, the bracket 104 can permit the light 106 to be adjusted about a single axis (e.g., up-and-down or side-to-side) or about multiple axes (e.g., up-and-down and side-to-side).

In the illustrated arrangement, the bracket 104 can be configured to allow up-and-down adjustment or rotational adjustment about a first (e.g., horizontal) axis 140 and side-to-side adjustment or rotational adjustment about a second (e.g., vertical) axis 142 that is perpendicular to the first axis 140. Thus, the light 106 can be separate from a first portion 144 of the bracket 104 and adjustable relative to the first portion 144 of the bracket 104 about the first axis 140. The bracket 104 can also include a second portion 146 that is separate from the first portion 144. In the illustrated arrangement, the second portion 146 is unitarily-formed with the rear ring 112. The first portion 144 and the second portion 146 can be adjustable to one another about the second axis 142. The light 106 can be secured to the first portion 144 of the bracket 104 and the first portion 144 of the bracket 104 can be secured to the second portion 146 of the bracket 104 by any suitable arrangement, such as fasteners (not shown) for example.

### CONCLUSION

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

What is claimed is:

1. An adjustable light assembly configured to be mounted to a vehicle grill, comprising:
a mounting ring configured to clamp onto a portion of the vehicle grill;
a light supporting member configured to support a light in alignment with a central opening of the mounting ring, wherein the light supporting member is connected to the mounting ring;
wherein the mounting ring and/or the light supporting member are configured to permit adjustment of the light relative to the mounting ring.

2. The light assembly of claim 1, wherein the mounting ring comprises a front ring and a rear ring that are connectable to one another and configured to receive the portion of the vehicle grill therebetween.

3. The light assembly of claim 2, wherein the front ring and the rear ring are configured to fix a position of the light supporting member relative to the mounting ring when front ring and the rear ring are clamped to the portion of the vehicle grill.

4. The light assembly of claim 1, wherein the mounting ring is circular.

5. The light assembly of claim 1, wherein the light supporting member and the mounting ring are coupled by a spheroidal joint.

6. The light assembly of claim 5, wherein the light supporting member supports a resilient ring member within the spheroidal joint.

7. The light assembly of claim 1, wherein the light supporting member is a bracket that is affixed to the mounting ring.

8. The light assembly of claim 7, wherein the bracket is affixed to one of the front ring and the rear ring
